(19) United States
(12) Patent Application Publication
(10) Pub. No.: US 2014/0317093 A1
(43) Pub. Date: Oct. 23, 2014

(54) FACILITATING DYNAMIC CREATION OF MULTI-COLUMN INDEX TABLES AND MANAGEMENT OF CUSTOMER QUERIES IN AN ON-DEMAND SERVICES ENVIRONMENT

(71) Applicant: salesforce.com, inc., San Francisco, CA (US)

(72) Inventors: WEI SUN, San Ramon, CA (US); Chun Tak Lam, Walnut Creek, CA (US); Jianxun Jason Ding, Cupertino, CA (US); Bing Qiu, Belmont, CA (US)

(73) Assignee: salesforce.com, inc., San Francisco, CA (US)

(21) Appl. No.: 14/257,570

(22) Filed: Apr. 21, 2014

Related U.S. Application Data
(60) Provisional application No. 61/814,459, filed on Apr. 22, 2013.

(51) Int. Cl. G06F 17/30

(52) U.S. Cl. CPC G06F 17/3033; G06F 17/30424
USPC 707/722; 707/747

(57) ABSTRACT

In accordance with embodiments, there are provided mechanisms and methods for facilitating dynamic creation of multi-column index tables and management of customer queries in an on-demand services environment in a multi-tenant environment according to one embodiment. In one embodiment and by way of example, a method includes receiving, at a computing device, a query having one or more filters relating to one or more data type columns of database at a primary table. The primary table may include an object table. The method may further include calculating a hash number based on an index identifier corresponding to the one or more filters, and determining a first key at a secondary table based on the calculated hash number. The secondary table may include an index table, and the first key may be mapped with a second key corresponding to one or more rows at the primary table. The method may further include obtaining data from the one or more rows of the primary table, where the data includes filtered data corresponding to the one or more data type columns.

### CLAIM OF PRIORITY

This application claims the benefit of and priority to U.S. Provisional Patent Application No. 61/814,459, entitled “Multiple Column Index for Custom Objects” by Wei Sun, filed Apr. 22, 2013, Attorney Docket No.: 8956P187Z, and the entire contents of which are incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### TECHNICAL FIELD

One or more implementations relate generally to data management and, more specifically, to a mechanism for facilitating dynamic creation of multi-column index tables and management of customer queries in an on-demand services environment.

### BACKGROUND

Often, organizations with large data sets, such as insurance companies, etc., desire to generate customer queries against data sets that often filter on multiple custom columns; however, existing custom indexes are unable to support more than two columns in production. As a result, customer queries that are generated on these large data sets consume and waste a great deal of time and resources as handling these queries can run rather inefficiently and unreasonably long. Some techniques (e.g., skinny tables) have been introduced to deal with these problems; however, such conventional techniques are expensive, inefficient, and cumbersome to implement and use. For example, one such technique includes building and employing skinny tables which requires that a skinny table be built and employed for each object per organization; consequently, this technique requires a great number of skinny tables to match the objects which can makes the technique expensive and not scalable.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches.

In conventional database systems, users access their data resources in one logical database. A user of such a conventional system typically retrieves data from and stores data on the system using the user's own systems. A user system might remotely access one of a plurality of server systems that might in turn access the database system. Data retrieval from the system might include the issuance of a query from the user system to the database system. The database system might process the request for information received in the query and send to the user system information relevant to the request. The secure and efficient retrieval of accurate information and subsequent delivery of this information to the user system has been and continues to be a goal of administrators of database systems. Unfortunately, conventional database approaches are associated with various limitations.

### BRIEF DESCRIPTION OF THE DRAWINGS

In the following drawings like reference numbers are used to refer to like elements. Although the following figures depict various examples, one or more implementations are not limited to the examples depicted in the figures.

FIG. 1 illustrates a computing device employing a mechanism for dynamic creation of multi-column index tables and management of customer queries according to one embodiment;

FIG. 2 illustrates a mechanism for dynamic creation of multi-column index tables and management of customer queries according to one embodiment;

FIG. 3 illustrates tables as facilitated by a mechanism for dynamic creation of multi-column index tables and management of customer queries according to one embodiment;

FIG. 4 illustrate a method for facilitating dynamic creation of multi-column index tables and management of customer queries in an on-demand services environment in a multi-tenant environment according to one embodiment;

FIG. 5 illustrates a computer system according to one embodiment;

FIG. 6 illustrates an environment wherein an on-demand database service might be used according to one embodiment; and

FIG. 7 illustrates elements of environment of FIG. 6 and various possible interconnections between these elements according to one embodiment.

### SUMMARY

In accordance with embodiments, there are provided mechanisms and methods for facilitating dynamic creation of multi-column index tables and management of customer queries relating to custom object tables in an on-demand services environment in a multi-tenant environment according to one embodiment. In one embodiment and by way of example, a method includes receiving, at a computing device, a query having one or more filters relating to one or more data type columns of database at a primary table. The primary table may include an object table. The method may further include calculating a hash number based on an index identifier corresponding to the one or more filters, and determining a first key at a secondary table based on the calculated hash number. The secondary table may include an index table, and the first key may be mapped with a second key corresponding to one or more rows at the primary table. The method may further include obtaining data from the one or more rows of the primary table, where the data includes filtered data corresponding to the one or more data type columns.

While the present invention is described with reference to an embodiment in which techniques for facilitating management of data in an on-demand services environment are implemented in a system having an application server providing a front end for an on-demand database service capable of supporting multiple tenants, the present invention is not limited to multi-tenant databases nor deployment on application servers. Embodiments may be practiced using other database architectures, i.e., ORACLE®, DB2® by IBM and the like without departing from the scope of the embodiments claimed.

Any of the above embodiments may be used alone or together with one another in any combination. Inventions encompassed within this specification may also include embodiments that are only partially mentioned or alluded to or are not mentioned or alluded to at all in this brief summary or in the abstract. Although various embodiments of the invention may have been motivated by various deficiencies with the prior art, which may be discussed or alluded to in one or more places in the specification, the embodiments of the invention do not necessarily address any of these deficiencies. In other words, different embodiments of the invention may address different deficiencies that may be discussed in the specification. Some embodiments may only partially address some deficiencies or just one deficiency that may be discussed in the specification, and some embodiments may not address any of these deficiencies.

### DETAILED DESCRIPTION

Methods and systems are provided for facilitating dynamic creation of multi-column index tables and management of multi-filter customer queries relating to custom object tables in an on-demand services environment in a multi-tenant environment according to one embodiment. In one embodiment and by way of example, a method includes ***.

Embodiments provide for facilitating dynamic creation of multi-column index tables and management of customer queries relating to custom object tables in an on-demand services environment in a multi-tenant environment according to one embodiment. In one embodiment, multi-column index tables include (but not limited to) a multi-column unified custom index table (also referred to as “secondary table”, “unified custom index table”, “unified table”, “unified index table” or simply “index table”), a multi-column description index table (also referred to as “tertiary table”, “description index table” or simply “description table”), etc., corresponding to a multi-column custom object table (also referred to as “primary table”, “main table”, “custom object table”, or simply “object table”). Details of these tables will be further described and explained throughout this document.

It is contemplated that embodiments and their implementations are not merely limited to multi-tenant database system (“MTDBS”) and can be used in other environment, such as a client-server system, a mobile device, a personal computer (PC), a web services environment, etc. However, for the sake of brevity and clarity, throughout this document, embodiments are described with respect to a multi-tenant database system, such as Salesforce.com®, which is to be regarded as an example of an on-demand environment.

In conventional models, index tables are severely limited in that an index table can only be created, for example, by a limitation of up to 2 columns and each column with up to 3 data types. As a result, a large number of index tables and/or skinny tables are required to be created and maintained and further, when they are relied upon for reference (such as when customer queries are to be processed) which can all be expensive, inefficient, and not scalable.

Embodiments facilitate a novel and innovative technique to expand the custom object indexing capability to generate and maintain a multi-column unified custom index table (serving as a secondary table) to corresponds to a custom object table (serving as a primary table) to support a combination of multiple columns (e.g., multi-columns greater than 2) and each column having the ability to hold multiple data types (e.g., greater than 3). For example and in one embodiment, this single or unified custom index table (e.g., Unified Index Table (UIT)) may be created to host multiple column indexes (also referred to as “indices”) to, for example, save resources by significantly lower the need for a large number of conventional tables and/or skinny tables while reducing the expensive and inefficient database table-join operations. Further, embodiments allow for optimizing management and execution of customer queries having multiple filters running on, for example, the cloud with very low overhead in both indexing time and query time and having to run on a single index in database in a multi-tenant environment.

As used herein, a term multi-tenant database system refers to those systems in which various elements of hardware and software of the database system may be shared by one or more customers. For example, a given application server may simultaneously process requests for a great number of customers, and a given database table may store rows for a potentially much greater number of customers. As used herein, the term query plan refers to a set of steps used to access information in a database system.

Embodiments are described with reference to an embodiment in which techniques for facilitating management of data in an on-demand services environment are implemented in a system having an application server providing a front end for an on-demand database service capable of supporting multiple tenants, embodiments are not limited to multi-tenant databases nor deployment on application servers. Embodiments may be practiced using other database architectures, i.e., ORACLE®, DB2® by IBM and the like without departing from the scope of the embodiments claimed.

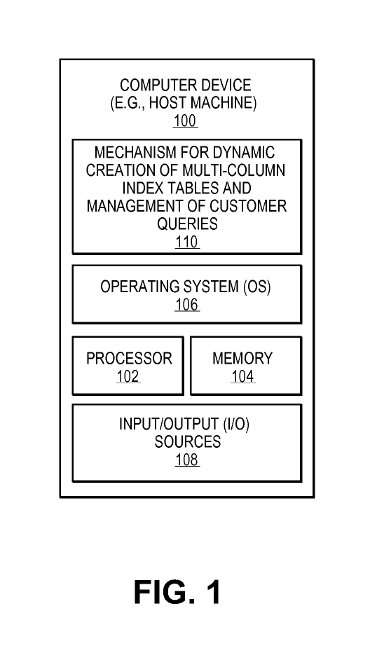

FIG. 1 illustrates a computing device 100 employing a mechanism for dynamic creation of multi-column index tables and management of customer queries 110 according to one embodiment. In one embodiment, computing device 100 serves as a host machine for employing mechanism for dynamic creation of multi-column index tables and management of multi-filter customer queries (“mechanism”) 110 for facilitating dynamic creation and management of custom index tables, such as description tables and unified index tables, corresponding to custom object tables and further, management, including evaluation and execution, of customer queries in a multi-tiered, multi-tenant, on-demand services environment.

The term “user” may refer to a system user, such as, but not limited to, a software/application developer, a system administrator, a database administrator, an information technology professional, a program manager, product manager, etc. The term “user” may also refer to an end-user, such as, but not limited to, an organization (e.g., a business, a company, a corporation, a non-profit entity, an institution, an agency, etc.) serving as a customer or client of the provider (e.g., Salesforce.com®) of mechanism 110 or an organization's representative, such as a salesperson, a sales manager, a product manager, an accountant, a director, an owner, a president, a computer programmer, an information technology (IT) representative, etc.

It is to be noted that any references to data and/or metadata (e.g., Customer Relationship Model (CRM) data and/or metadata, etc.), tables (e.g., custom object table, unified index tables, description tables, etc.), computing devices (e.g., server computers, desktop computers, mobile computers, such as tablet computers, smartphones, etc.), software development languages, applications, and/or development tools or kits (e.g., Force.com®, Force.com Apex™ code, JavaScript™, jQuery™, Developerforce™, Visualforce™, Service Cloud Console Integration Toolkit™ (“Integration Toolkit” or “Toolkit”), Platform on a Service™ (PaaS), Chatter® Groups, Sprint Planner®, MS Project®, etc.), domains (e.g., Google®, Facebook®, LinkedIn®, Skype®, etc.), etc., discussed in this document are merely used as examples for brevity, clarity, and ease of understanding and that embodiments are not limited to any particular number or type of data, metadata, tables, computing devices, techniques, programming languages, software applications, software development tools/kits, etc.

Computing device 100 may include server computers (e.g., cloud server computers, etc.), desktop computers, cluster-based computers, set-top boxes (e.g., Internet-based cable television set-top boxes, etc.), and the like. Computing device 100 may also include smaller computers, such as mobile computing devices, such as cellular phones including smartphones (e.g., iPhone® by Apple®, BlackBerry® by Research in Motion® Limited, now known and trading as BlackBerry®, etc.), handheld computing devices, personal digital assistants (PDAs), etc., tablet computers (e.g., iPad® by Apple®, Galaxy® by Samsung®, etc.), laptop computers (e.g., notebooks, netbooks, Ultrabook™ systems, etc.), e-readers (e.g., Kindle® by Amazon.com®, Nook® by Barnes and Nobles®, etc.), Global Positioning System (GPS)-based navigation systems, cable setup boxes, etc.

Computing device 100 includes an operating system (OS) 106 serving as an interface between any hardware or physical resources of the computing device 100 and a user. Computing device 100 further includes one or more processors 102, memory devices 104, network devices, drivers, or the like, as well as input/output (I/O) sources 108, such as touchscreens, touch panels, touch pads, virtual or regular keyboards, virtual or regular mice, etc. It is to be noted that terms like “node”, “computing node”, “server”, “server device”, “cloud computer”, “cloud server”, “cloud server computer”, “machine”, “host machine”, “device”, “computing device”, “computer”, “computing system”, “multi-tenant on-demand data system”, and the like, may be used interchangeably throughout this document. It is to be further noted that terms like “application”, “software application”, “program”, “software program”, “package”, and “software package” may be used interchangeably throughout this document. Moreover, terms like “job”, “input”, “request” and “message” may be used interchangeably throughout this document.

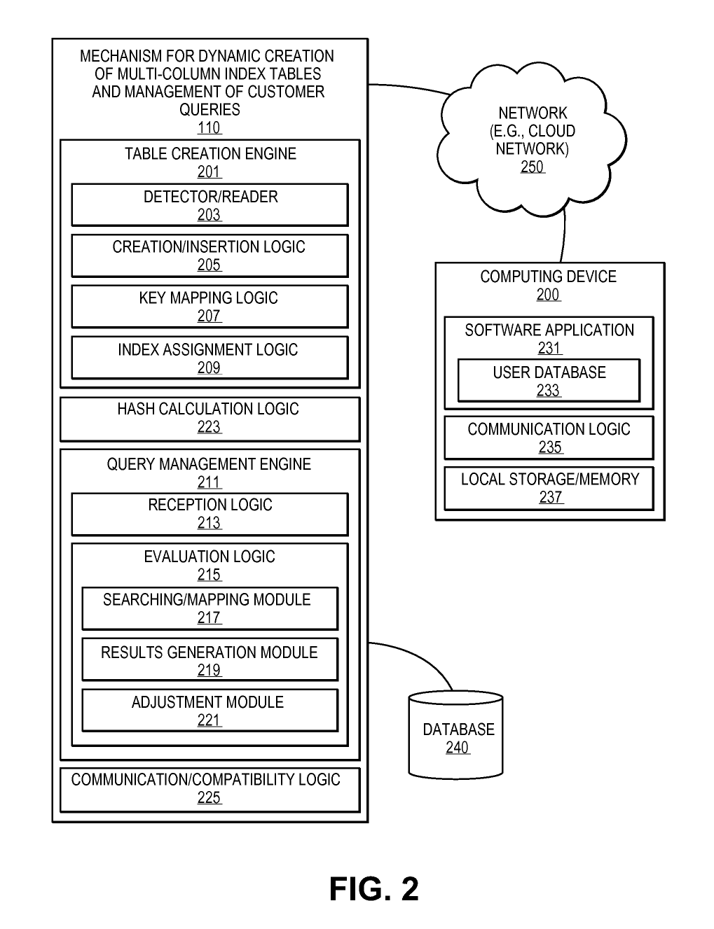

FIG. 2 illustrates a mechanism for dynamic creation of multi-column index tables and management of customer queries 110 according to one embodiment. In one embodiment, mechanism 110 may include a number of components, such as: table creation engine 201 having detector/reader 203, creation/insertion logic 205, key mapping logic 207, and index assignment logic 209; queue management engine 211 including reception logic 213, evaluation logic 215 having searching/mapping module 217, results generation module 219, and adjustment module 221; hash calculation logic 223; and communication/compatibility logic 225.

In one embodiment, mechanism 110 may be employed by a host machine, such as computing device 100 of FIG. 1, in communication with one or more databases, such as database 240, one or more computing devices, such as computing device 200 serving as a client computing device, over one or more networks, such as network 250 (e.g., cloud network, Internet, etc.). In one embodiment, computing device 200 may include: software application 231 providing user interface 233; communication logic 235; and local storage/memory 237 which may be in communication with one or more local databases or remote databases, such as database 240 over network 250, such as a cloud computing network.

Throughout this document, “logic”, “component”, “module”, “framework”, and “engine” may be referenced interchangeably and include, by way of example, software, hardware, and/or any combination of software and hardware, such as firmware. Further, any use of a particular brand, word, or term, such as “custom index table”, “index table”, “custom object table”, “object table”, “main table”, “primary table”, “secondary table”, “tertiary table”, “descriptive table”, “hash”, “index”, “data type”, “column”, “row”, “table”, etc., should not be read to limit embodiments to software or devices that carry that label in products or in literature external to this document.

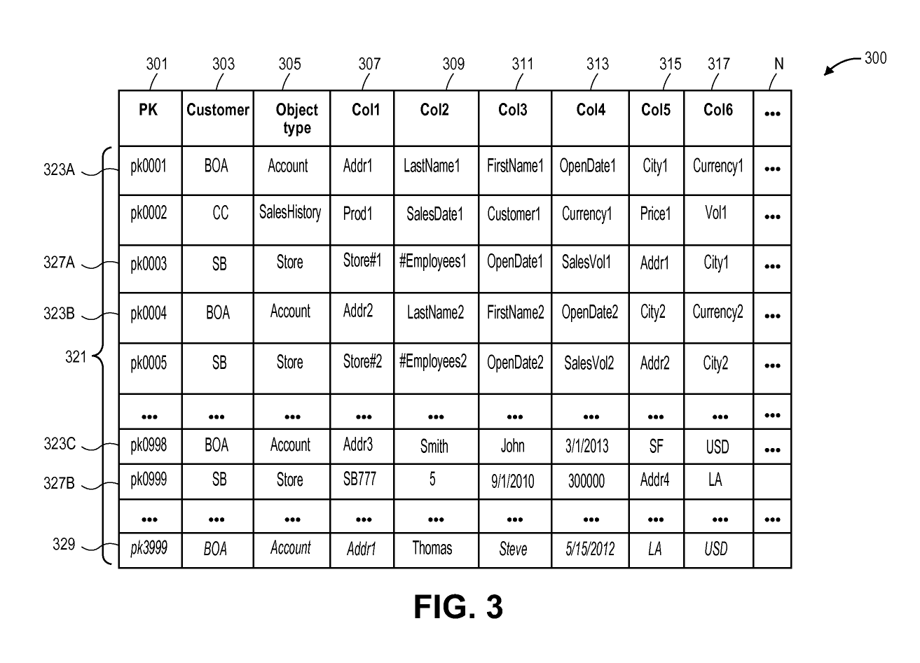

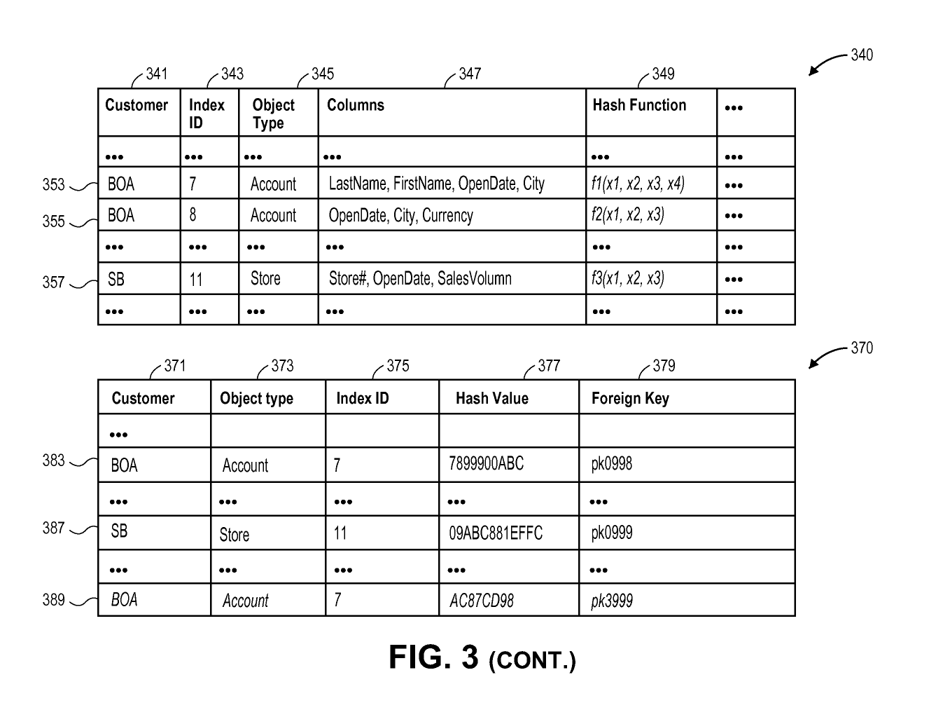

As aforementioned and further described with reference to FIG. 3, most large organizations (e.g., customers, such as companies, big or small businesses, government agencies, non-profit organizations, educational institutions, etc.) may have large datasets (e.g., names, dates, locations, number of employees, store numbers, sales volume, etc.) which may be obtained from each organization and put into a primary table (e.g., custom object table), by a service provider (e.g., Salesforce.com) so that a large amount of data relating to the organizations can be conveniently maintained by the service provider. Although the primary table may be useful in having a large amount of data in one place, it can be rather cumbersome and inefficient to deal with such large amount of data when, for example, dealing with customer queries having multiple filters for requiring bits and pieces of information relating to various portions or segments of the corresponding data. In one embodiment, a much smaller secondary unified single table (e.g., a single multi-column unified custom index table), rather than multiple discrete tables, may be generated and maintained having data efficiently linking to the main table through one or more of hash values, index numbers, and foreign keys.

Furthermore, in one embodiment, a tertiary or description table (e.g., multi-column description index table) may be created and maintained to have descriptive metadata for providing additional information and serving as, for example, a link between the primary and second tables. In one embodiment, upon receiving a customer query (such as a query having any number and type of filters to filter in and out certain data), the corresponding secondary and description tables may be used to, based on the query filters, obtain only the relevant records from the primary table which may then be returned to the customer placing the query.

In one embodiment, using detector/reader 203, various existing and/or newly added rows of a primary table (such as custom object table 300 of FIG. 3) may be detected and upon detection, data contained within each of those rows may be read for processing. For example, an organization may want to have several rows of data (such as last name, first name, sales date, currency, city, etc.) based on various data types (such as string, integer, date, etc.) and relating to particular employees, clients, customers, internal departments, competitors, transactions, store locations, countries, products, projects, etc., maintained at the primary table being maintained and managed by the service provider.

In one embodiment, using creation/insertion logic 205, a tertiary or description table may be created, where a description table (such as multi-column description index table 370 of FIG. 3) may include a multi-column description index table having a number of columns and rows holding descriptive information or metadata relating to each of the rows of the primary table. For example, an embodiment of a descriptive table may list or include (but not limited to) organization name, index number or identification (ID), organization object or business/product description, description of data type columns relating to an organization's particular row in the primary table, hash function, etc., as detected and/or read by detector/reader 203 and mapped by key mapping logic 207. In one embodiment, an index ID may be assigned by index assignment logic 209 and correspond to one or more data types in each column which may then be used to map or correspond to various filters contained within a customer query as further described with reference to FIG. 3.

Similarly, using creating/insertion logic 205, a secondary or unified index table (such as multi-column unified custom index table 370 of FIG. 3) may be created and maintained. This secondary table, for example, may be a unified table such that only a single table may be needed to be referred to or relied upon in response to or when processing a customer query. An embodiment of a secondary table may include a number of rows and columns listing or including (but not limited to) organization name, organization object or business/product description, index ID, hash value, foreign key, etc. In one embodiment, hash values of the secondary table may be calculated based on one or more hash functions obtained from the description table and using hash calculation logic 223. Further, using key mapping logic 207, foreign keys of the secondary table may be generated to be the same as or properly mapped to the corresponding primary keys of the primary table.

Moreover, as aforementioned, the description and secondary tables may be continuously updated, using creation/insertion logic 205, by modifying existing rows and columns to keep up with any changes being made to the corresponding rows of the primary table. For example, an organization may choose to modify one or more data types, such as replace city name, a string, with currency, an integer, for a row corresponding to a particular product of the organization, or simply choose to add a data type, such as number of employees, an integer, or sales date, a date, etc., and correspondingly, the description and secondary tables may also be modified to reflect the one or more modification to the primary table. Similarly, as further described with reference to FIG. 3, when a new row for an organization is added to or an existing row is removed from the primary table, a corresponding new row is added to or removed from the description and secondary tables.

In one embodiment, these multi-column description and secondary tables are efficiently and promptly used when a customer query is received by reception logic 211 and subsequently, evaluated by evaluation logic 215. For example, at evaluation logic 215, searching/mapping module 217 performs an optimizer search for the corresponding index ID at the description table, where evaluation logic 215 detects or determines the corresponding index ID by detecting and/or reading the number and type of filters contained within the query. The filters may be provided by a user at an organization to obtain a customized set of results to the query. For example, the user may set the filter to ask for data relating to certain data types, such as last name, first name, date, and city, for a particular product. Once the filters are detected or read from the query, they are matched, by searching/mapping module 217, with the corresponding index ID at the description table.

Upon obtaining the index ID, searching/mapping module 217 may further use the description table to obtain one or more hash functions corresponding to the index ID. Using the filters and the hash functions, hash calculation logic 223 may calculate hash values as defined by the index ID and the corresponding hash functions as provided in the description table. It is contemplated that any number and type of hash value calculation techniques may be employed for generation and using of these hash values. In one embodiment, using searching/mapping module 217, the calculated hash value is associated with a foreign key that directly corresponds to a primary key at the primary table. Once the hash value is known (or calculated based on the hash function), the corresponding foreign key may then be used to find one or more rows in the primary table associated with the corresponding primary key. Upon locating the one or more record or rows at the primary table, any data from those records may be obtained from the primary table and appropriate converted into results by results generation logic 219. In case of any conflicts or collision of hash values, the query evaluation process may be adjusted by adjustment module 221 and continuously rerun until proper records are obtained and appropriate results are generated.

Once generated, the results are then communicated back to computing device 200 via communication/compatibility logic 225 and communication logic 235, where the results are presented at computing device 200 in one or more formats (e.g., text, table, graph, etc.) via user interface 233. The results may be locally stored at local storage 237 and additional queries may be placed via software application 231 over network 250.

Communication/compatibility logic 225 may facilitate the ability to dynamically communicate and stay configured with any number and type of software/application developing tools, models, data processing servers, database platforms and architectures, programming languages and their corresponding platforms, etc. Communication/compatibility logic 225 further facilitates the ability to dynamically communicate and stay configured with various computing devices (e.g., server computing device, mobile computing devices, such as smartphones, tablet computers, laptop, etc.), networks (e.g., cloud network, intranet, the Internet, proximity network, such as Bluetooth®, WiFi®, etc.), websites (e.g., social networking websites, such as Facebook®, LinkedIn®, Google+®, Twitter®, etc.), and the like, while ensuring compatibility with changing technologies, parameters, protocols, standards, etc.

It is contemplated that any number and type of components may be added to and/or removed from mechanism 110 to facilitate various embodiments including adding, removing, and/or enhancing certain features. For brevity, clarity, ease of understanding, many of the standard and/or known components, such as those of a computing device, are not shown or discussed here. It is contemplated that embodiments are not limited to any particular technology, topology, system, architecture, and/or standard and are dynamic enough to adopt and adapt to any future changes.

FIG. 3 illustrates tables 300, 340, 370 as facilitated by a mechanism for dynamic creation of multi-column index tables and management of customer queries 110 according to one embodiment. In one embodiment and for example, primary table 300, such as a custom object table, may include data relating to a number of customers, such as Bank of America® (“BOA”), Coca-Cola® (“CC”), and Starbucks® (“SB”). Similarly, the illustrated embodiment further describes description table 340, such as a multi-column description index table, and secondary table 370, such as a multi-column unified custom index table. It is contemplated that these tables 300, 340, 370 are for illustration purposes and that embodiments are not limited to these tables 300, 340, 370, the number and/or size of rows and columns shown for tables 300, 340, 370, data types (e.g., string, integer, and date) of these tables 300, 340, 370, and/or any of the contents of tables 300, 340, 370, such as number and type of customers, their names or any of the other corresponding data. Further, for brevity, clarity, and ease of understanding, many of the components and processes described with respect to FIGS. 1-2 may not be repeated here.

As aforementioned, primary table 300 represent a main custom object table having data relating to BOA, CC, and SB that are shown to occupy any number of rows 321 and columns 301-N. It is to be noted that tables 300, 340, 370 are not limited any particular number or size of rows and/or columns or their contents. As illustrated, the first three data columns 301-305 are shown to include private keys (e.g., PK0001, PK0999, etc.) in column 301, customer names (e.g., BOA, CC, SB, etc.) in column 303, and customer object/record type (e.g., account, store, sales history, etc.). Similarly, data columns 1-6 307-317 may include other customer-related data of various data types, such as string (e.g., last name, first name, address, city name, etc.), integer (e.g., currency, store number, sales volume, etc.), date (e.g., store open date, sales date, etc.), and the like.

As described with reference to FIG. 2, using the data being maintained in primary table 300, in one embodiment, index tables, such as description table 340 and secondary table 370, may be created and continuously maintained. For example, as illustrated, description table 340 may contain some of the basic data similar to that of primary table 300, such as customer names in column 341, customer object types in column 345, etc. However, in one embodiment, description table 340 may include additional and/or different information from that of primary table 300, such as index IDs in column 343, column data type combinations in column 347, hash functions in column 349, etc.

In one embodiment, index IDs of column 343 at description table 340 may be generated based on column data type combinations of column 347 that may be used as filters by customers when placing queries. For example, a customer query may include certain data types, such as last name (as an string), currency (as an integer), city (as a string), open date (as a date), etc., as filters to customize the query to limit the query results to only relevant data while filtering out irrelevant information so that the results may meet their business needs without waiting time and/or resources. Each customer may want to build indexes on specific column data types based on their own business needs and thus, they may index on different database columns having various data types.

For example, BOA (such as rows 323A-C of primary table 300) may wish to build an index based on last name, first name, open date, and city corresponding to database columns 309, 311, 313 and 315, respectively, of primary table 300 and this index may be assigned an identification number, such as 7. Accordingly, using this example, index ID 7 may comprise or be associated with a particular sequence of data types, such as last name (as a string), first name (as a string), open date (as a date), and city (as a string). Similarly, in one embodiment, hash functions of column 347, such as ƒ1, may be generated and assigned to their corresponding index IDs of column 343, such as index ID 7, which may then be used to calculate hash values of column 377 of secondary table 370. In one embodiment, a corresponding row, such as row 353, is added to description table 340, where row 353 corresponds to BOA (of row 323C, pk0998, of primary table 300) having assigned index ID 7 and hash function ƒ1(x1, x2, x3, x4), where x1 represents last name, x2 represents first name, x3 represents open date, and x4 represents city.

It is contemplated that customers may wish to have and maintain multiple indexes with different combinations of filters to be associated with multiple queries to be placed by the customer to facilitate an efficiently navigation through a large number of records in primary table 300 so that only the relevant data may be obtained in query results. For example, in a multi-tenant environment, there may be a large number of tenants (or customers) which may mean having and maintaining a large number of indexes (as each customer may wish to have and maintain multiple indexes). For example, BOA may want to have another index comprising a combination of open date (as a date), city (as a string), and currency (as an integer) corresponding to columns 313, 315, and 317, respectively, of primary table 300. As with the previous example of index ID 7, this combination of data types (e.g., open date (as a date), city (as a string), and currency (as an integer)) may be assigned a different index ID number, such as index ID 8. Similarly, as with the previous example relating to index ID 7, a different hash function, such as ƒ2(x1, x2, x3), may be generated and associated with index ID 8, wherein x1 represents open date, x2 represents city, and x3 represents currency. In one embodiment, a corresponding row, such as row 355, may then be added to description table 340.

Similarly, yet another row, such as row 357, may be added to description table 340, representing a different customer, such as SB (of rows 327A-B of primary table 300), with an index having a data types combination of store# (as an integer), open date (as a date), and sales volume (as an integer) corresponding to columns 307, 311 and 313, respectively, of primary table 300, an assigned index ID, such as index ID 11, and an assigned hash function, such as ƒ3(x1, x2, x3), where x1 represents store#, x2 represents open date, and x3 represents sales volume.

In one embodiment, using the information of description table 340, secondary table 370, such as a multi-column unified index table, may be generate and maintained to provide and assign hash values in column 377 and foreign keys in column 379 corresponding to private keys of column 301 of primary table 300. For brevity and ease of understanding, columns 383 and 387 of secondary table 370 are shown to correspond to columns 353 and 357 of description table 340.

In embodiment, having accessed or obtained index IDs and hash functions of columns 343 and 347, respectively, of description table 340, hash values may be generated and assigned based on the corresponding index IDs and hash functions and maintained in column 377 of secondary table 370. For example, using hash calculation logic 223 of FIG. 2, hash values in column 377 may be generated to correspond to index IDs in column 375 and foreign keys in column 379, customers in column 371, and object types in column 373 of secondary table 370. For example, as illustrated, ƒ1(Smith, John, 3/1/2013, SFO)=7899900ABC, where 7899900ABC is regarded as the calculated hash value for row 383 of secondary table 370, where the customer is BOA, the index ID is 7, and the foreign key is pk0998 that corresponds to private key pk0998 of row 323C of primary table 300. Similarly, ƒ3(SB777, 9/1/2010, 30,000)=09ABC881EFFC, where 09ABC881EFFC is regarded as the calculated hash value for row 387 of secondary table 370, wherein the customer is SB, the index ID is 11, and the foreign key is pk0999 that corresponds to private key pk0999 of primary table 300.

Now suppose a new record or row, such as row 329, is added to primary table 300. Row 329 may include new and/or additional data relating to a new or existing customer, such as BOA. In one embodiment, using the aforementioned processes, a corresponding new row, such as row 389, may be added to secondary table 370. If, for example, BOA has requested the same data types or index as index ID 7, such as a data types combination of last name (string), first name (string), open date (date), and city (string), then, in one embodiment and as previously described, the same index number, such as index ID 7, and its corresponding hash function, such as ƒ1(x1, x2, x3, x4), may be associated with this new row 329. Accordingly, using index ID 7 and hash function ƒ1(x1, x2, x3, x4), in one embodiment, a new hash value may be calculated, such as ƒ1 (Thomas, Steve, 5/15/2012, LA)=AC87CD98, and placed in column 377, where AC87CD98 is regarded as the calculated hash value for new row 389 of secondary table 370, wherein customer is BOA, index ID is 7, foreign key is pk3999 that corresponds to private key pk3999 of primary table 300.

In one embodiment, a combination of one or more of tables 300, 340, 370 may then be used to handle subsequently-received customer queries having various filters corresponding to customer-requested indexes. For example, a customer query may include the following filters:

select Addr, Currency from BOA_Account_Table

where LastName=‘Smith’
and FirstName=‘John’
and OpenDate=‘3/1/2013’
and City=‘SFO’;

Upon receiving the query, it may be evaluated for optimized conditions. For example and in one embodiment, from description table 340, custom index ID 7 is found and selected because it corresponds to the index of last name, first name, open date, and city to match all the filters of the query. Similarly, the aforementioned corresponding hash function (e.g., ƒ1(x1, x2, x3, x4)) is obtained from description table 340 and upon selecting the index ID and the hash function, a hash value is calculated based on the filters and the hash function as defined for customer index ID 7, such as ƒ1(Smith, John, ‘3/1/2013’, SFO)=7899900ABC.

Then, in one embodiment, using the calculated hash value, a corresponding foreign key, such as pk0998, is selected from secondary table 370 for the record that is to be obtained from primary table 300 in response to the query. For example, foreign key pk0998 in column 379 and row 383 of secondary table 370 and any other foreign keys whose hash value equals 7899900ABC may be selected. Based on the information available, such as index ID, hash value, etc., the foreign key may be selected as:

select Foreign_Key from unified_index_table

where Customer=‘BOA’
and Index ID=‘index7’
and ObjectType=‘Account’
and HashValue=7899900ABC;

Having selected the foreign key, it may then be mapped to locate the corresponding private key in primary table 300, such as private key pk0998 of row 323C and column 301 of primary table 300. Using the mapped private key, such as pk0998, its corresponding record, such as the record in row 323C of primary table 300, is extracted and placed into query results and returned to the customer to view at one or more client computing devices over one or more networks, such as a cloud network.

It is contemplated that in rare cases, more than one record may be triggered because of a hash function collision. In that case, a process against the triggered records and/or filters may be run and rerun to filter out the hash function collision; this process may run as:

select Addr, Currency from main_data_table

where PK in [Foreign Keys returned from Step 3]
and Customer=‘BOA’
and ObjectType=‘Account’
and LastName=‘Smith’
and FirstName=‘John’
and OpenDate=‘3/1/2013’
and City=‘SFO’;

In one embodiment, various common hash functions may be used and implemented to create and operate description and secondary tables 340, 370 that are then used for efficient management of customer database and queries. For example, a cryptographic hash function, such as sha256, may be used and its usage may be all strings/dates/integers/keys as the input may be concatenated as one input and passes in sha256, where sha256 may be good at generating a relatively even hash distribution to avoid hash function collisions. Further, when a hash function collision happens, the correctness of index creations and handling of customer queries may not be affected by the collision because, as aforementioned, the filters are repeatedly and continuously checked until all hash collisions may be removed or appropriately managed.

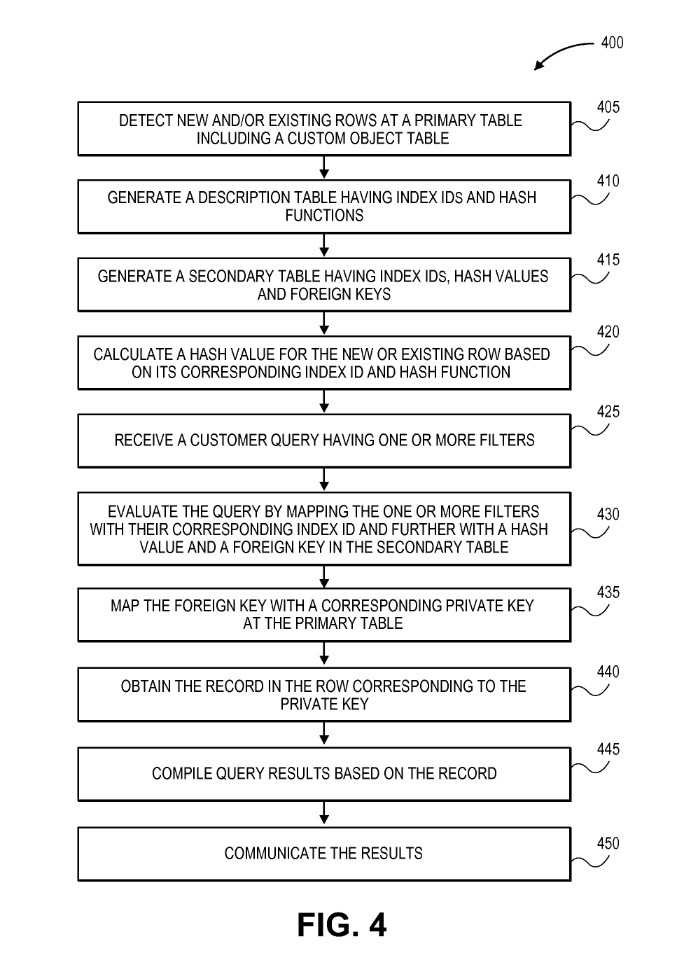

FIG. 4 illustrates a method for facilitating dynamic creation of multi-column index tables and management of customer queries in an on-demand services environment in a multi-tenant environment according to one embodiment. Method 400 may be performed by processing logic that may comprise hardware (e.g., circuitry, dedicated logic, programmable logic, etc.), software (such as instructions run on a processing device), or a combination thereof. In one embodiment, method 400 may be performed by mechanism for dynamic creation of multi-column index tables and management of multi-filter customer queries 110 of FIG. 1. The processes of method 400 are illustrated in linear sequences for brevity and clarity in presentation; however, it is contemplated that any number of them can be performed in parallel, asynchronously, or in different orders.

Method 400 begins at block 405 with detecting new and/or existing rows at a primary table, such as a custom object table, where a new row having information relating to a customer may be added and/or an existing row may be modified. At block 410, in one embodiment, a description table, such as a multi-column description index table, may be created and maintained having description or metadata relating to the data contained within the rows and columns of the primary table. Further, in one embodiment, index IDs and hash functions are generated and placed in the description table, where a combination of an index ID and a hash function may correspond to each record contained within each row of the description table. As previously discussed, each index ID may be generated based on the index requested by a customer, wherein the customer-requested index may include a combination of dataset columns relating to various data types (e.g., last name (string), first name (string), city (string), open date (date), hiring date (date), termination date (date), currency (integer), sales volume (integer), number of employees (integer), etc.) that may be anticipated as being subsequently used by the customer as filters in future customer queries.

In one embodiment, at block 415, a secondary table, such as a multi-column unified custom index table is generated to hold and maintain index IDs obtained from the description table as well as hash values based that are calculated using hash functions obtained from the description table. The secondary table may further contain foreign keys, where each foreign key corresponds to a private key corresponding to a row in the primary table. The secondary table may include various columns referring to (but not limited to) customer name, customer object type, hash values, index IDs, foreign keys, etc.

At block 420, using the index IDs and their corresponding hash functions as obtained from the description table, hash values may be calculated using one or more hash calculation techniques and placed in a column in the secondary table. For example, each calculated hash value may then represent an index ID which in turn represents one or more dataset columns relating to data types and the relevant data contained within a corresponding row in the primary table. In other words, a simply hash value may be used to represent one or more records which saves a great deal of resources and time when, for example, handling customer queries.

At block 425, a customer query having multiple filters is received. The multiple filters may indicate data relating to one or more columns having data that the user is interested in receiving; for example, the filters in the query may include (but not limited to) last name (string), first name (string), currency (integer), open date (date), etc. At block 430, the query is evaluated based on the filters by matching the filters with their corresponding index ID and further with their calculated hash values and foreign keys from the secondary table. At block 435, for example and in one embodiment, one or more foreign keys relating to the query may be found and matched with its corresponding one or more private keys at the primary table. Once the one or more private keys are found, their one or more corresponding records obtained from their one or more rows of the primary table at block 440. At block 445, these records are generated into query results which, in response to the customer query, are then communicated to the customer via one or more client computing devices over one or more networks at block 450.

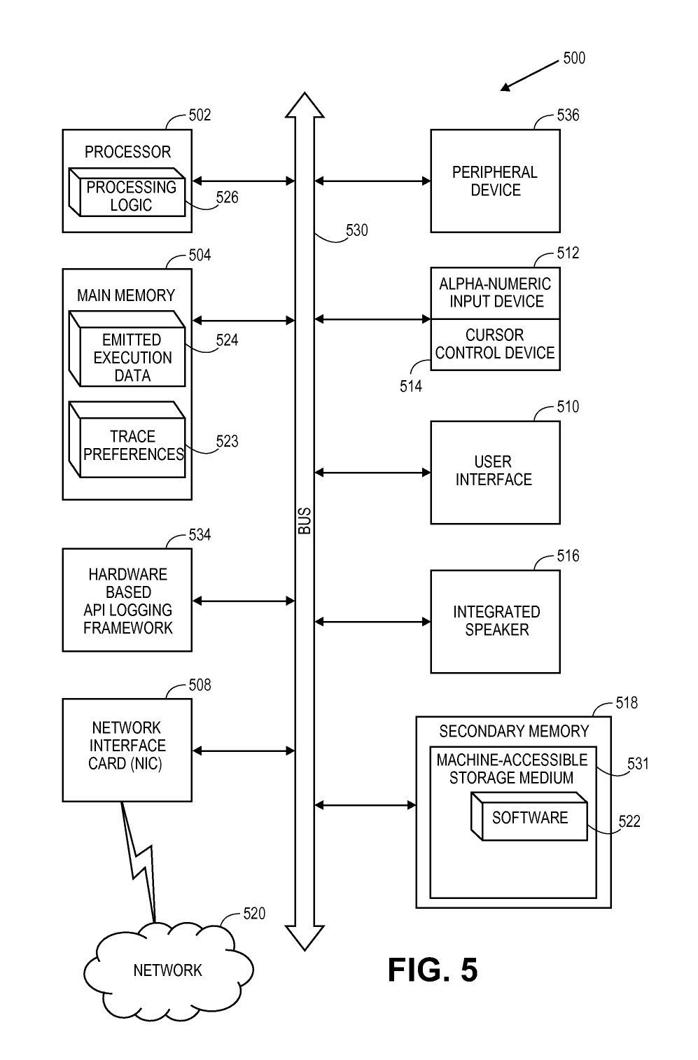

FIG. 5 illustrates a diagrammatic representation of a machine 500 in the exemplary form of a computer system, in accordance with one embodiment, within which a set of instructions, for causing the machine 500 to perform any one or more of the methodologies discussed herein, may be executed. Machine 500 is the same as or similar to computing device 100 and computing device 200 of FIG. 1 and FIG. 2, respectively. In alternative embodiments, the machine may be connected (e.g., networked) to other machines in a network (such as host machine 100 of FIG. 1 connected with client machine 200 over network 250 of FIG. 2), such as a cloud-based network, a Local Area Network (LAN), a Wide Area Network (WAN), a Metropolitan Area Network (MAN), a Personal Area Network (PAN), an intranet, an extranet, or the Internet. The machine may operate in the capacity of a server or a client machine in a client-server network environment, or as a peer machine in a peer-to-peer (or distributed) network environment or as a server or series of servers within an on-demand service environment, including an on-demand environment providing multi-tenant database storage services. Certain embodiments of the machine may be in the form of a personal computer (PC), a tablet PC, a set-top box (STB), a Personal Digital Assistant (PDA), a cellular telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers) that individually or jointly execute a set (or multiple sets) of instructions to perform any one or more of the methodologies discussed herein.

The exemplary computer system 500 includes a processor 502, a main memory 504 (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory 518 (e.g., a persistent storage device including hard disk drives and persistent multi-tenant data base implementations), which communicate with each other via a bus 530. Main memory 504 includes emitted execution data 524 (e.g., data emitted by a logging framework) and one or more trace preferences 523 which operate in conjunction with processing logic 526 and processor 502 to perform the methodologies discussed herein.

Processor 502 represents one or more general-purpose processing devices such as a microprocessor, central processing unit, or the like. More particularly, the processor 502 may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor 502 may also be one or more special-purpose processing devices such as an application specific integrated circuit (ASIC), a field programmable gate array (FPGA), a digital signal processor (DSP), network processor, or the like. Processor 502 is configured to execute the processing logic 526 for performing the operations and functionality of dynamic database table and customer query management mechanism 110 as described with reference to FIG. 1 other figures discussed herein.

The computer system 500 may further include a network interface card 508. The computer system 500 also may include a user interface 510 (such as a video display unit, a liquid crystal display (LCD), or a cathode ray tube (CRT)), an alphanumeric input device 512 (e.g., a keyboard), a cursor control device 514 (e.g., a mouse), and a signal generation device 516 (e.g., an integrated speaker). The computer system 500 may further include peripheral device 536 (e.g., wireless or wired communication devices, memory devices, storage devices, audio processing devices, video processing devices, etc. The computer system 500 may further include a Hardware based API logging framework 534 capable of executing incoming requests for services and emitting execution data responsive to the fulfillment of such incoming requests.

The secondary memory 518 may include a machine-readable storage medium (or more specifically a machine-accessible storage medium) 531 on which is stored one or more sets of instructions (e.g., software 522) embodying any one or more of the methodologies or functions of mechanism for dynamic creation of multi-column index tables and management of multi-filter customer queries 110 as described with reference to FIG. 1 and other figures discussed herein. The software 522 may also reside, completely or at least partially, within the main memory 504 and/or within the processor 502 during execution thereof by the computer system 500, the main memory 504 and the processor 502 also constituting machine-readable storage media. The software 522 may further be transmitted or received over a network 520 via the network interface card 508. The machine-readable storage medium 531 may include transitory or non-transitory machine-readable storage media.

Portions of various embodiments may be provided as a computer program product, which may include a computer-readable medium having stored thereon computer program instructions, which may be used to program a computer (or other electronic devices) to perform a process according to the embodiments. The machine-readable medium may include, but is not limited to, floppy diskettes, optical disks, compact disk read-only memory (CD-ROM), and magneto-optical disks, ROM, RAM, erasable programmable read-only memory (EPROM), electrically EPROM (EEPROM), magnet or optical cards, flash memory, or other type of media/machine-readable medium suitable for storing electronic instructions.

The techniques shown in the figures can be implemented using code and data stored and executed on one or more electronic devices (e.g., an end station, a network element). Such electronic devices store and communicate (internally and/or with other electronic devices over a network) code and data using computer-readable media, such as non-transitory computer-readable storage media (e.g., magnetic disks; optical disks; random access memory; read only memory; flash memory devices; phase-change memory) and transitory computer-readable transmission media (e.g., electrical, optical, acoustical or other form of propagated signals—such as carrier waves, infrared signals, digital signals). In addition, such electronic devices typically include a set of one or more processors coupled to one or more other components, such as one or more storage devices (non-transitory machine-readable storage media), user input/output devices (e.g., a keyboard, a touchscreen, and/or a display), and network connections. The coupling of the set of processors and other components is typically through one or more busses and bridges (also termed as bus controllers). Thus, the storage device of a given electronic device typically stores code and/or data for execution on the set of one or more processors of that electronic device. Of course, one or more parts of an embodiment may be implemented using different combinations of software, firmware, and/or hardware.

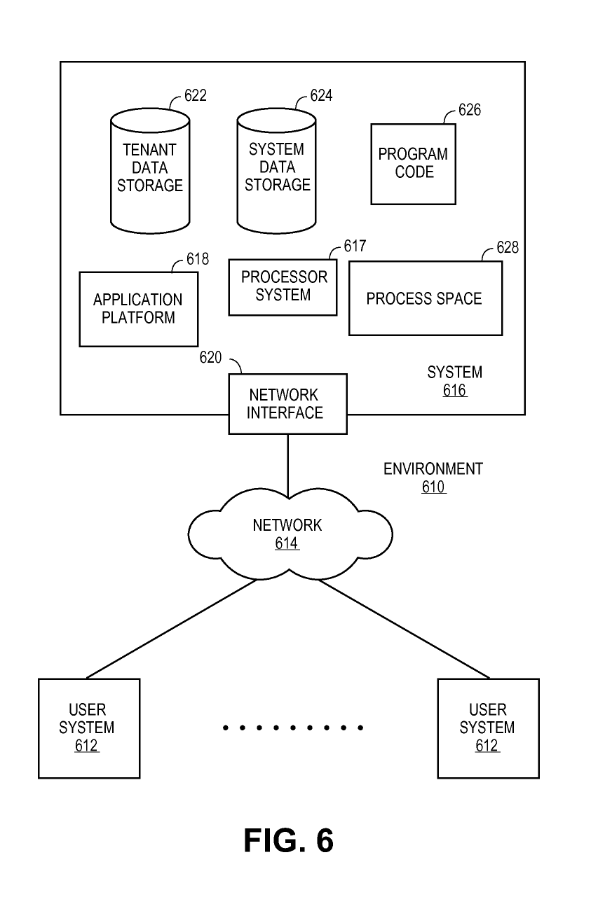

FIG. 6 illustrates a block diagram of an environment 610 wherein an on-demand database service might be used. Environment 610 may include user systems 612, network 614, system 616, processor system 617, application platform 618, network interface 620, tenant data storage 622, system data storage 624, program code 626, and process space 628. In other embodiments, environment 610 may not have all of the components listed and/or may have other elements instead of, or in addition to, those listed above.

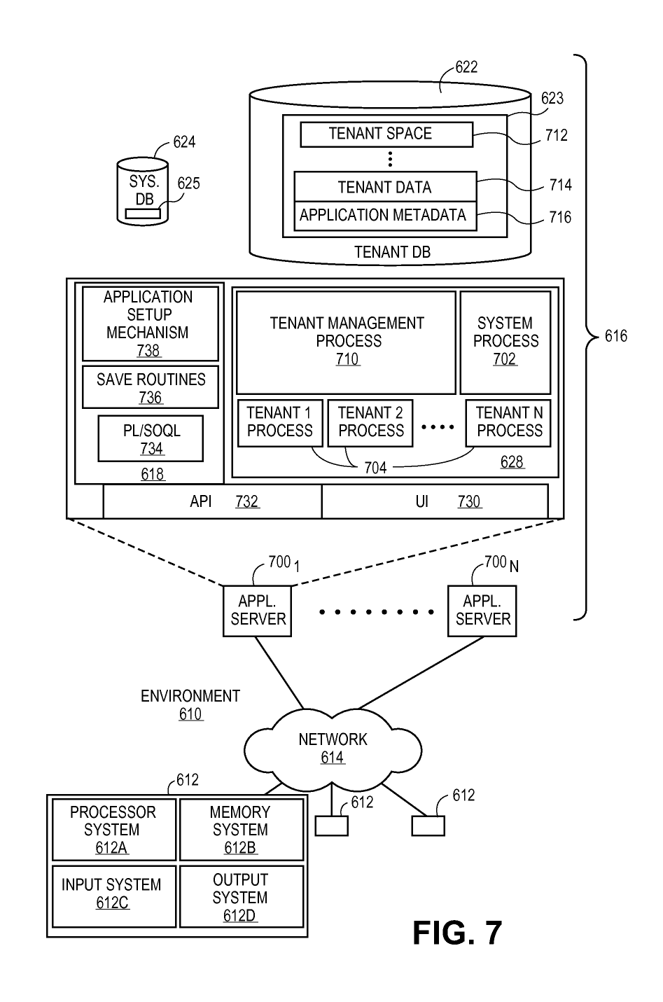

Environment 610 is an environment in which an on-demand database service exists. User system 612 may be any machine or system that is used by a user to access a database user system. For example, any of user systems 612 can be a handheld computing device, a mobile phone, a laptop computer, a work station, and/or a network of computing devices. As illustrated in herein FIG. 6 (and in more detail in FIG. 7) user systems 612 might interact via a network 614 with an on-demand database service, which is system 616.

An on-demand database service, such as system 616, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, “on-demand database service 616” and “system 616” will be used interchangeably herein. A database image may include one or more database objects. A relational database management system (RDMS) or the equivalent may execute storage and retrieval of information against the database object(s). Application platform 618 may be a framework that allows the applications of system 616 to run, such as the hardware and/or software, e.g., the operating system. In an embodiment, on-demand database service 616 may include an application platform 618 that enables creation, managing and executing one or more applications developed by the provider of the on-demand database service, users accessing the on-demand database service via user systems 612, or third party application developers accessing the on-demand database service via user systems 612.

The users of user systems 612 may differ in their respective capacities, and the capacity of a particular user system 612 might be entirely determined by permissions (permission levels) for the current user. For example, where a salesperson is using a particular user system 612 to interact with system 616, that user system has the capacities allotted to that salesperson. However, while an administrator is using that user system to interact with system 616, that user system has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

Network 614 is any network or combination of networks of devices that communicate with one another. For example, network 614 can be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that one or more implementations might use are not so limited, although TCP/IP is a frequently implemented protocol.

User systems 612 might communicate with system 616 using TCP/IP and, at a higher network level, use other common Internet protocols to communicate, such as HTTP, FTP, AFS, WAP, etc. In an example where HTTP is used, user system 612 might include an HTTP client commonly referred to as a “browser” for sending and receiving HTTP messages to and from an HTTP server at system 616. Such an HTTP server might be implemented as the sole network interface between system 616 and network 614, but other techniques might be used as well or instead. In some implementations, the interface between system 616 and network 614 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, system 616, shown in FIG. 6, implements a web-based customer relationship management (CRM) system. For example, in one embodiment, system 616 includes application servers configured to implement and execute CRM software applications as well as provide related data, code, forms, webpages and other information to and from user systems 612 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared. In certain embodiments, system 616 implements applications other than, or in addition to, a CRM application. For example, system 616 may provide tenant access to multiple hosted (standard and custom) applications, including a CRM application. User (or third party developer) applications, which may or may not include CRM, may be supported by the application platform 618, which manages creation, storage of the applications into one or more database objects and executing of the applications in a virtual machine in the process space of the system 616.

One arrangement for elements of system 616 is shown in FIG. 6, including a network interface 620, application platform 618, tenant data storage 622 for tenant data 623, system data storage 624 for system data 625 accessible to system 616 and possibly multiple tenants, program code 626 for implementing various functions of system 616, and a process space 628 for executing MTS system processes and tenant-specific processes, such as running applications as part of an application hosting service. Additional processes that may execute on system 616 include database indexing processes.

Several elements in the system shown in FIG. 6 include conventional, well-known elements that are explained only briefly here. For example, each user system 612 could include a desktop personal computer, workstation, laptop, PDA, cell phone, or any wireless access protocol (WAP) enabled device or any other computing device capable of interfacing directly or indirectly to the Internet or other network connection. User system 612 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of user system 612 to access, process and view information, pages and applications available to it from system 616 over network 614. User system 612 further includes Mobile OS (e.g., iOS® by Apple®, Android®, WebOS® by Palm®, etc.). Each user system 612 also typically includes one or more user interface devices, such as a keyboard, a mouse, trackball, touch pad, touch screen, pen or the like, for interacting with a graphical user interface (GUI) provided by the browser on a display (e.g., a monitor screen, LCD display, etc.) in conjunction with pages, forms, applications and other information provided by system 616 or other systems or servers. For example, the user interface device can be used to access data and applications hosted by system 616, and to perform searches on stored data, and otherwise allow a user to interact with various GUI pages that may be presented to a user. As discussed above, embodiments are suitable for use with the Internet, which refers to a specific global internetwork of networks. However, it should be understood that other networks can be used instead of the Internet, such as an intranet, an extranet, a virtual private network (VPN), a non-TCP/IP based network, any LAN or WAN or the like.

According to one embodiment, each user system 612 and all of its components are operator configurable using applications, such as a browser, including computer code run using a central processing unit such as an Intel Core® processor or the like. Similarly, system 616 (and additional instances of an MTS, where more than one is present) and all of their components might be operator configurable using application(s) including computer code to run using a central processing unit such as processor system 617, which may include an Intel Pentium® processor or the like, and/or multiple processor units. A computer program product embodiment includes a machine-readable storage medium (media) having instructions stored thereon/in which can be used to program a computer to perform any of the processes of the embodiments described herein. Computer code for operating and configuring system 616 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), microdrive, and magneto-optical disks, and magnetic or optical cards, nanosystems (including molecular memory ICs), or any type of media or device suitable for storing instructions and/or data. Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments can be implemented in any programming language that can be executed on a client system and/or server or server system such as, for example, C, C++, HTML, any other markup language, Java™ JavaScript, ActiveX, any other scripting language, such as VBScript, and many other programming languages as are well known may be used. (Java™ is a trademark of Sun Microsystems, Inc.).

According to one embodiment, each system 616 is configured to provide webpages, forms, applications, data and media content to user (client) systems 612 to support the access by user systems 612 as tenants of system 616. As such, system 616 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations. Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein can be implemented as single databases, a distributed database, a collection of distributed databases, a database with redundant online or offline backups or other redundancies, etc., and might include a distributed database or storage network and associated processing intelligence.

FIG. 7 also illustrates environment 610. However, in FIG. 7 elements of system 616 and various interconnections in an embodiment are further illustrated. FIG. 7 shows that user system 612 may include processor system 612A, memory system 612B, input system 612C, and output system 612D. FIG. 7 shows network 614 and system 616. FIG. 7 also shows that system 616 may include tenant data storage 622, tenant data 623, system data storage 624, system data 625, User Interface (UI) 730, Application Program Interface (API) 732, PL/SOQL 734, save routines 736, application setup mechanism 738, applications servers 700₁-700_{N}, system process space 702, tenant process spaces 704, tenant management process space 710, tenant storage area 712, user storage 714, and application metadata 716. In other embodiments, environment 610 may not have the same elements as those listed above and/or may have other elements instead of, or in addition to, those listed above.

User system 612, network 614, system 616, tenant data storage 622, and system data storage 624 were discussed above in FIG. 6. Regarding user system 612, processor system 612A may be any combination of one or more processors. Memory system 612B may be any combination of one or more memory devices, short term, and/or long term memory. Input system 612C may be any combination of input devices, such as one or more keyboards, mice, trackballs, scanners, cameras, and/or interfaces to networks. Output system 612D may be any combination of output devices, such as one or more monitors, printers, and/or interfaces to networks. As shown by FIG. 7, system 616 may include a network interface 620 (of FIG. 6) implemented as a set of HTTP application servers 700, an application platform 618, tenant data storage 622, and system data storage 624. Also shown is system process space 702, including individual tenant process spaces 704 and a tenant management process space 710. Each application server 700 may be configured to tenant data storage 622 and the tenant data 623 therein, and system data storage 624 and the system data 625 therein to serve requests of user systems 612. The tenant data 623 might be divided into individual tenant storage areas 712, which can be either a physical arrangement and/or a logical arrangement of data. Within each tenant storage area 712, user storage 714 and application metadata 716 might be similarly allocated for each user. For example, a copy of a user's most recently used (MRU) items might be stored to user storage 714. Similarly, a copy of MRU items for an entire organization that is a tenant might be stored to tenant storage area 712. A UI 730 provides a user interface and an API 732 provides an application programmer interface to system 616 resident processes to users and/or developers at user systems 612. The tenant data and the system data may be stored in various databases, such as one or more Oracle™ databases.

Application platform 618 includes an application setup mechanism 738 that supports application developers' creation and management of applications, which may be saved as metadata into tenant data storage 622 by save routines 736 for execution by subscribers as one or more tenant process spaces 704 managed by tenant management process 710 for example. Invocations to such applications may be coded using PL/SOQL 734 that provides a programming language style interface extension to API 732. A detailed description of some PL/SOQL language embodiments is discussed in commonly owned U.S. Pat. No. 7,730,478 entitled, “Method and System for Allowing Access to Developed Applicants via a Multi-Tenant Database On-Demand Database Service”, issued Jun. 1, 2010 to Craig Weissman, which is incorporated in its entirety herein for all purposes. Invocations to applications may be detected by one or more system processes, which manage retrieving application metadata 716 for the subscriber making the invocation and executing the metadata as an application in a virtual machine.

Each application server 700 may be communicably coupled to database systems, e.g., having access to system data 625 and tenant data 623, via a different network connection. For example, one application server 700₁ might be coupled via the network 614 (e.g., the Internet), another application server 700_{N-1} might be coupled via a direct network link, and another application server 700_{N} might be coupled by yet a different network connection. Transfer Control Protocol and Internet Protocol (TCP/IP) are typical protocols for communicating between application servers 700 and the database system. However, it will be apparent to one skilled in the art that other transport protocols may be used to optimize the system depending on the network interconnect used.

In certain embodiments, each application server 700 is configured to handle requests for any user associated with any organization that is a tenant. Because it is desirable to be able to add and remove application servers from the server pool at any time for any reason, there is preferably no server affinity for a user and/or organization to a specific application server 700. In one embodiment, therefore, an interface system implementing a load balancing function (e.g., an F5 Big-IP load balancer) is communicably coupled between the application servers 700 and the user systems 612 to distribute requests to the application servers 700. In one embodiment, the load balancer uses a least connections algorithm to route user requests to the application servers 700. Other examples of load balancing algorithms, such as round robin and observed response time, also can be used. For example, in certain embodiments, three consecutive requests from the same user could hit three different application servers 700, and three requests from different users could hit the same application server 700. In this manner, system 616 is multi-tenant, wherein system 616 handles storage of, and access to, different objects, data and applications across disparate users and organizations.

As an example of storage, one tenant might be a company that employs a sales force where each salesperson uses system 616 to manage their sales process. Thus, a user might maintain contact data, leads data, customer follow-up data, performance data, goals and progress data, etc., all applicable to that user's personal sales process (e.g., in tenant data storage 622). In an example of a MTS arrangement, since all of the data and the applications to access, view, modify, report, transmit, calculate, etc., can be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by system 616 that are allocated at the tenant level while other data structures might be managed at the user level. Because an MTS might support multiple tenants including possible competitors, the MTS should have security protocols that keep data, applications, and application use separate. Also, because many tenants may opt for access to an MTS rather than maintain their own system, redundancy, up-time, and backup are additional functions that may be implemented in the MTS. In addition to user-specific data and tenant specific data, system 616 might also maintain system level data usable by multiple tenants or other data. Such system level data might include industry reports, news, postings, and the like that are sharable among tenants.

In certain embodiments, user systems 612 (which may be client systems) communicate with application servers 700 to request and update system-level and tenant-level data from system 616 that may require sending one or more queries to tenant data storage 622 and/or system data storage 624. System 616 (e.g., an application server 700 in system 616) automatically generates one or more SQL statements (e.g., one or more SQL queries) that are designed to access the desired information. System data storage 624 may generate query plans to access the requested data from the database.

Each database can generally be viewed as a collection of objects, such as a set of logical tables, containing data fitted into predefined categories. A “table” is one representation of a data object, and may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields. For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. patent application Ser. No. 10/817,161, filed Apr. 2, 2004, entitled “Custom Entities and Fields in a Multi-Tenant Database System”, and which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

Any of the above embodiments may be used alone or together with one another in any combination. Embodiments encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements. It is to be understood that the above description is intended to be illustrative, and not restrictive.

What is claimed is:

1. A method comprising:
receiving, at a computing device, a query having one or more filters relating to one or more data type columns of a database at a primary table, wherein the primary table includes an object table;
calculating a hash number based on an index identifier corresponding to the one or more filters;
determining a first key at a secondary table based on the calculated hash number, wherein the secondary table includes an index table, wherein the first key is mapped with a second key corresponding to one or more rows at the primary table; and
obtaining a set of data from the one or more rows of the primary table, wherein the set of data includes filtered data corresponding to the one or more data type columns.

2. The method of claim 1, further comprising:
compiling query results including the filtered data; and
communicating the query results to a customer via a computing device over a network, wherein the query is received from the customer via the computing device and wherein the one or more rows include data relating to the customer.

3. The method of claim 1, further comprising generating a description table having metadata associated with the database at the primary table, wherein the metadata to describe a plurality of segments of the database, wherein the metadata includes index identifiers and hash functions, wherein a hash function is assigned to each index identifier.

4. The method of claim 3, wherein each index identifier is assigned to an index having one or more sets of filters corresponding to one or more sets of data type columns of the database at the primary table, wherein the one or more sets of filters are defined by one or more customers to customize one or more queries.

5. The method of claim 1, further comprising generating the secondary table comprising hash values, wherein each hash value is calculated based on a corresponding hash function as identified by its corresponding index identifier.

6. The method of claim 5, wherein the secondary table further comprises at least one of the index identifiers and a first plurality of keys corresponding to a second plurality of keys of the primary table, wherein the first plurality of keys include the first key, wherein each of the second plurality of keys corresponds to a row of the database at the primary table.

7. An apparatus comprising:
reception logic to receive, at a computing device, a query having one or more filters relating to one or more data type columns of a database at a primary table, wherein the primary table includes an object table;
hash calculation logic to calculate a hash number based on an index identifier corresponding to the one or more filters;
searching/mapping module to determine a first key at a secondary table based on the calculated hash number, wherein the secondary table includes an index table, wherein the first key is mapped with a second key corresponding to one or more rows at the primary table; and
results generation module to obtain a set of data from the one or more rows of the primary table, wherein the set of data includes filtered data corresponding to the one or more data type columns.

8. The apparatus of claim 7, wherein the results generation logic to compile query results including the filtered data, and wherein the apparatus further comprises:
communication/compatibility logic to communicate the query results to a customer via a computing device over a network, wherein the query is received from the customer via the computing device and wherein the one or more rows include data relating to the customer.

9. The apparatus of claim 7, further comprising creation/insertion logic to generate a description table having metadata associated with the database at the primary table, wherein the metadata to describe a plurality of segments of the database, wherein the metadata includes index identifiers and hash functions, wherein a hash function is assigned to each index identifier.

10. The apparatus of claim 9, wherein each index identifier is assigned, via index assignment logic, to an index having one or more sets of filters corresponding to one or more sets of data type columns of the database at the primary table, wherein the one or more sets of filters are defined by one or more customers to customize one or more queries.

11. The apparatus of claim 7, further comprising creation/insertion logic to generate the secondary table comprising hash values, wherein each hash value is calculated based on a corresponding hash function as identified by its corresponding index identifier.

12. The apparatus of claim 11, wherein the secondary table further comprises at least one of the index identifiers and a first plurality of keys corresponding to a second plurality of keys of the primary table, wherein the first plurality of keys include the first key, wherein each of the second plurality of keys corresponds to a row of the database at the primary table.

13. A system comprising:
a computing device having a memory to store instructions, and a processing device to execute the instructions, the computing device further having a mechanism to perform one or more operations comprising:
receiving, at a computing device, a query having one or more filters relating to one or more data type columns of a database at a primary table, wherein the primary table includes an object table;
calculating a hash number based on an index identifier corresponding to the one or more filters;
determining a first key at a secondary table based on the calculated hash number, wherein the secondary table includes an index table, wherein the first key is mapped with a second key corresponding to one or more rows at the primary table; and
obtaining a set of data from the one or more rows of the primary table, wherein the set of data includes filtered data corresponding to the one or more data type columns.

14. The system of claim 13, wherein the one or more operations further comprise:
compiling query results including the filtered data; and
communicating the query results to a customer via a computing device over a network, wherein the query is received from the customer via the computing device and wherein the one or more rows include data relating to the customer.

15. The system of claim 13, wherein the one or more operations further comprise generating a description table having metadata associated with the database at the primary table, wherein the metadata to describe a plurality of segments of the database, wherein the metadata includes index identifiers and hash functions, wherein a hash function is assigned to each index identifier.

16. The system of claim 15, wherein each index identifier is assigned to an index having one or more sets of filters corresponding to one or more sets of data type columns of the database at the primary table, wherein the one or more sets of filters are defined by one or more customers to customize one or more queries.

17. The system of claim 13, wherein the one or more operations further comprise generating the secondary table comprising hash values, wherein each hash value is calculated based on a corresponding hash function as identified by its corresponding index identifier.

18. The system of claim 17, wherein the secondary table further comprises at least one of the index identifiers and a first plurality of keys corresponding to a second plurality of keys of the primary table, wherein the first plurality of keys include the first key, wherein each of the second plurality of keys corresponds to a row of the database at the primary table.

19. A machine-readable medium comprising a plurality of instructions which, when executed by a processing device, cause the processing device to perform one or more operations comprising:
receiving, at a computing device, a query having one or more filters relating to one or more data type columns of a database at a primary table, wherein the primary table includes an object table;
calculating a hash number based on an index identifier corresponding to the one or more filters;
determining a first key at a secondary table based on the calculated hash number, wherein the secondary table includes an index table, wherein the first key is mapped with a second key corresponding to one or more rows at the primary table; and
obtaining a set of data from the one or more rows of the primary table, wherein the set of data includes filtered data corresponding to the one or more data type columns.

20. The machine-readable medium of claim 19, wherein the one or more operations further comprise:
compiling query results including the filtered data; and
communicating the query results to a customer via a computing device over a network, wherein the query is received from the customer via the computing device and wherein the one or more rows include data relating to the customer.

21. The machine-readable medium of claim 20, wherein the one or more operations further comprise generating a description table having metadata associated with the database at the primary table, wherein the metadata to describe a plurality of segments of the database, wherein the metadata includes index identifiers and hash functions, wherein a hash function is assigned to each index identifier.

22. The machine-readable medium of claim 19, wherein each index identifier is assigned to an index having one or more sets of filters corresponding to one or more sets of data type columns of the database at the primary table, wherein the one or more sets of filters are defined by one or more customers to customize one or more queries.

23. The machine-readable medium of claim 19, wherein the one or more operations further comprise generating the secondary table comprising hash values, wherein each hash value is calculated based on a corresponding hash function as identified by its corresponding index identifier.

24. The machine-readable medium of claim 23, wherein the secondary table further comprises at least one of the index identifiers and a first plurality of keys corresponding to a second plurality of keys of the primary table, wherein the first plurality of keys include the first key, wherein each of the second plurality of keys corresponds to a row of the database at the primary table.
